(19) United States
(12) Patent Application Publication
(10) Pub. No.: US 2006/0166024 A1
(43) Pub. Date: Jul. 27, 2006

(54) Antimicrobial melamine resin and products

(75) Inventors: Ivan W. Ong, Charlotte, NC (US); William D. Hanrahan, Charlotte, NC (US)

Correspondence Address: CLIFF D. WESTON;MICROBAN PRODUCTS COMPANY, 1115 VANSTORY DRIVE, SUITE 125, HUNTERSVILLE, NC, 28078, US

(73) Assignee: Microban Products Company, Huntersville, NC (US)

(21) Appl. No.: 11/268,023

(22) Filed: Nov. 7, 2005

Related U.S. Application Data
(63) Continuation-in-part of application No. 10/521,987, filed on Jan. 21, 2005.

(51) Int. Cl. B32B 27/42; A01N 25/34

(52) U.S. Cl. 428/524; 428/530; 424/413

(57) ABSTRACT

An antimicrobial melamine resin includes an antimicrobial agent incorporated therein. The melamine resin is useful for making melamine-based decorative laminate articles having a tough, mar-resistant antimicrobial surface and for molded melamine articles exhibiting antimicrobial properties.

### CROSS-REFERENCES TO RELATED APPLICATION

This application is a continuation-in-part of U.S. Ser. No. 10/521,987, filed on 21 Jan. 2005, the disclosure of which is incorporated by reference herein in its entirety for all purposes.

### BACKGROUND OF THE INVENTION

1) Field of the Invention

The present invention relates to an antimicrobial melamine resin, and more particularly to a melamine resin having therein an antimicrobial agent and the surface coatings, decorative laminates and molded articles that can be formed therewith.

2) Prior Art

Melamine resins are widely used for surface coatings and decorative laminates, such as paper-based and wood-based laminates. These types of coatings or decorative laminates are formed from photographic prints or decorative sculptured paper impregnated with melamine resin, which is placed on a core material and cured in a large press. The kraft paper impregnated with the melamine resin is very compatible with the melamine resin and costs less than multiple layers of impregnated paper.

Melamine resins have one of the hardest surfaces of any commercial material. Native hardness, along with excellent grease and water resistance, low flammability, and clarity of the plastic, has led to the usefulness of melamine formaldehyde as a surface coating.

Melamine countertop materials generally are thin sheets composed of heavy paper or thin cardboard backing bonded to the back side of a patterned paper. The bonding material is thin and usually but not always phenolic, which may be foamed. The top layer of paper is impregnated with melamine formaldehyde. The laminate is heated and subjected to pressure to attain a complete cure. The finished material generally is between two to four millimeters thick, up to about two meters in width, and sold as a roll in lengths. The roll sheet can be adhesively bonded to a substrate (e.g., wooden base) to make countertop, flooring, furniture, etc.

Melamine coating also may be employed in flooring products. For example, a flooring article can have a top layer of melamine formaldehyde that is heated under pressure to fuse to a wood layer or other substrate. The top layer is highly resistant to scuffs, stains, and wear, yet transparent to allow the wood grain (real or simulated) to show through.

Melamine resin is compatible with a wide variety of fillers and has been used for many molded parts because of the resultant hardness. Many products—such as molded dinnerware, plastic dishes, and cups—made from the melamine resin are hard, stain-resistant, and produced at relatively low cost.

There is a need to create antimicrobial tabletops, countertops, dinnerware, kitchenware, and flooring, which could be used in either a residential or commercial setting. More specifically, a restaurant having tabletops, countertops in the kitchen, and flooring throughout the restaurant—any of which would desirably exhibit antimicrobial properties—would reduce the probability of worker or food contamination from salmonella, E. coli, and other bacteria and fungi that might otherwise colonize thereon.

Although melamine resin and its uses are known to those skilled in the art, it has proven quite difficult to produce a melamine resin having antimicrobial properties, as opposed to a topical treatment that only has a temporary and very short-lived duration. Additionally, certain classes of antimicrobial agents may react with or otherwise be assimilated into the melamine, such that they are incorporated into the resin and no longer exhibit antimicrobial properties.

Peroxide has been identified as an antifungal and mildewcidal agent suitable for melamine resins in Japan Publication JP 10-119221. The peroxide is added at a concentration of 0.1 to 0.8 parts per 100 parts melamine. One problem associated with peroxide is that it rapidly degrades when heated, therefore having shortened sustained antimicrobial properties. At higher concentrations, the peroxide also negatively affects the melamine resin bath life.

Antibacterial phosphate cocktails have been employed, such as antibacterial phosphates combined with silver, benzalkonium, cetypiridinium and isopropylmethylphenol (Japan Publication JP 07-329265). This antibacterial mixture is added both to the overlay sheet (or the printed sheet) and to the underlying kraft paper, the latter then being impregnated with phenolic resins.

The use of phosphates is disadvantageous in that it requires a secondary antimicrobial, in part because phosphates are themselves a food source for a number of elemental plants and animals (bacteria and fungi).

It would also be preferable to concentrate the antimicrobial in the overlay sheet or the topmost aspect of the surface coating, so that the antimicrobial agent resides in the portion of the product that microbes will come in contact with.

### DESCRIPTION OF THE PREFERED EMBODIMENTS

In the broadest sense, the present antimicrobial melamine resin is a permanent resin comprising melamine and an antimicrobial agent. The antimicrobial agent is substantially inert with respect to the melamine resin and present within the melamine resin in an amount effective to provide antimicrobial properties. An antimicrobial agent is substantially uniformly dispersed within the resin, such that an article manufactured using the antimicrobial melamine exhibits antimicrobial properties for the life of the melamine layer.

Melamine (C₃H₆N₆) is a white crystalline solid. Combining it with formaldehyde results in the formation of a compound referred to as a methylol derivative. With additional formaldehyde (CHO), the melamine reacts to form tri-, tetra-, penta-, and hexamethylol-melamine. While commercial melamine resins may be obtained without the use of catalyst, both heating and catalyst are used to speed polymerization and curing.

Decorative laminates are usually assembled with a core of several sheets of phenolic or melamine resin impregnated kraft paper. The core is surfaced with a melamine formaldehyde impregnated sheet, which is often printed with a decorative design. Finally, a thin melamine resin-impregnated overlay sheet is applied. The sheets are impregnated by being passed through a resin bath, and followed by controlled moisture drying.

The curing of melamine resins is quickened by the use of heat and acid catalyst, while the overall pH is usually neutral or slightly alkaline. The addition of acid catalyst provides a source for protons, but the level of addition is generally kept lower than alkalinity produced by the amines.

The present antimicrobial melamine resin contemplates a resin of melamine; alkylated melamines such as methylated melamines, butylated melamines, or isobutylated melamines; melamines containing imino resins such as methylated imino resins, butylated imino resins, or isobutylated imino resins; urea resins such as methylated urea resins, butylated urea resins, isobutylated urea resins; formaldehyde resins; benzoguanamine resins; and glycoluril resins.

Effective antimicrobial agents are preferably those that have a relatively low vapor pressure. Triclosan (2,4,4′-trichloro-2′-hydroxydiphenyl ether), which is a diphenyl ether (bis-phenyl) derivative, is a particularly efficacious agent. It has a vapor pressure of 4×10⁻⁴ mm at 20° C. On the other hand, ortho phenyl phenol (OPP; CAS No. 90-43-7), which has a boiling point of 280° C., is generally considered too volatile to be employed except in applications necessitating superior resistance to bio-fouling. The combination of OPP and triclosan has been found to exhibit synergistic effects and, in products having a melamine formaldehyde coating where anti-bio fouling properties is desired, the use of OPP can be justified.

Isothiazolone-based compounds selected from the group consisting of 1,2-benzisothiazolin-3-one (CAS No. 2634-33-5); N-butyl-1,2-benzisothiazolin-3-one (CAS No. 4299-07-4); 2-octyl-isothiazolone (CAS No. 26530-20-1); 4,5-dichloro-2-N-octyl-3(2H)-isothiazolone (CAS No. 64359-81-5); methyl-3(2H)-isothiazolone (CAS No. 2682-20-4); and chloro-2-methyl-3(2H)-isothiazolone (CAS No. 26172-55-4) have been found to be efficacious antimicrobial agents.

Additional antimicrobial agents suitable for use in the melamine resin disclosed herein include diiodomethyl p-tolylsulfone; zinc and sodium pyrithiones; azoles (such as propiconazoles), polyhexamethylene biguanide hydrochloride (PMBH); 3,4,4′-trichlorocarbanilide; titanium dioxide; and barium metaborate(H₂0).

Silver, copper or zinc can also be used in various forms, such as in zeolite or amorphous glass powder. Silver, for example, alternatively may be utilized in the present melamine resin in elemental form or in sol/gel form; the general concept being that the inorganic antimicrobial be disposed in the melamine resin product in an ion exchangeable form. In some cases, it may be desirable to add a dispersing agent with the antimicrobial agent to prevent agglomeration of the antimicrobial agent in the melamine resin.

The antimicrobial agent(s) is/are dispersed in the melamine resin bath prior to impregnation of kraft paper or molding of an article. As one example, the antimicrobial agent may be delivered as a fine divided powder diluted in a liquid forming a dispersion, which can be admixed with the melamine formaldehyde resins prior to the application of the resins. The dispersion is 15% to 65% solids by weight, and commonly 50% by weight, of the active antimicrobial agent. The weight percent addition of the antimicrobial agent is about 0.1% to about 5%, with a preferred range of about 0.3% to about 1.0% of the weight of the melamine resin. Zinc oxide also can be added to the dispersion to stabilize the antimicrobial agent.

In a representative decorative laminate application (e.g. a flooring or countertop article), the laminate is comprised of a high-density core which is generally constructed of one or more layers of fiberboard. A melamine-formaldehyde impregnated printed paper sheet is adhered thereon. The impregnated printed paper can be patterned to have a desired design, such as marble, wood or the like. A melamine-formaldehyde impregnated overlay sheet typically is laid over the paper sheet.

Commonly, the printed paper sheet and the overlay sheet are pre-impregnated with the melamine formaldehyde resin prior to forming the laminate. The fiberboard is usually impregnated with a phenolic or melamine resin. The pre-impregnation of the printed paper and the overlay enables the melamine formaldehyde sufficient time to thoroughly wet-out the substrate, which in turn drives out any remaining entrapped air. Following saturation, the carrier (e.g. water and/or solvent) is dried off, leaving the sheet saturated with the compounded melamine formaldehyde amine.

The melamine formaldehyde resin is usually applied as a compounded resin/water or resin/water/solvent saturate. Solvents commonly used in melamine formaldehyde compositions are rather complex mixtures of two or more solvents and typically include aromatics such as toluene, xylene or Solvesso150 (Exxon); alcohols such as butanol, isobutanol, methanol, ethanol, or isopropanol; esters such as cellosolve acetate, ethyl acetate, or isopropyl acetate; ketones such as isophorone, methyl ethyl ketone, or acetone; alcohol amines such as dimethylethanolamine or dimethylisopropanolamine; and ethers such as butyl cellosolve.

The use of solvents generally is reserved for impregnating difficult-to-saturate paper. Certain grades of kraft paper are either too dense, too hydrophobic, or a combination of the two to be saturated to a sufficient pick up level to achieve the desired properties with a pure water-borne system. More open, porous paper sheets can be saturated with water/latex systems, which generally have the advantage of a lower raw material cost.

Compounding additives, in addition to the antimicrobial agent, can include: surface active agents such as wetting agents, surfactants, de-aeratants, and defoamers; anti-blocking agents; catalysts such as PTSA (para-toluene sulfonic acid), MSA (methane sulfonic acid), oxalic acid, ammonium nitrate and ammonium chloride; fillers; pigments; dielectric modifiers; glossing agents; and dyes.

Latent acid catalysts, such as those having a fugitive counter ion, like ammonium nitrate and ammonium chloride, are preferred where the storage time will be lengthy. Generally speaking, the strong acid catalysts are used in melamine formaldehyde systems where the melamine is highly methylated, such as hexamethoxymethylmelamine.

It is necessary only that the antimicrobial agent be added to the overlay to impart antimicrobial properties to the laminate. It is contemplated that migration into the printed paper layer may occur, as antimicrobial (and particularly bactericidal) performance remains efficacious at the 0.1% weight of melamine level.

The representative laminate is formed by combining the overlay, the printed paper and the fiberboard in a heated press. Prototypical cure times are from about 15 seconds to several minutes at from about 127° C. to about 290° C. Pressures are on the order of from about 1000 pounds per square inch (psi) to about 5000 psi.

In another example, the antimicrobial agent(s) can also be added directly to a melamine formaldehyde resin where the melamine formaldehyde resin is being used as a surface coating. The antimicrobial agent can be incorporated into the bath through which the kraft paper passes, for example. When the melamine formaldehyde resin is employed to make molded articles such as dinnerware, cups, chopping blocks, and the like, the antimicrobial agent also can be incorporated directly into the melamine molding resin.

Suitable antimicrobial agents for the present antimicrobial melamine resin may be 2,4,4′-trichloro-2′-hydroxydiphenyl ether (“triclosan”); 2-phenylphenol; poly(hexamethylene biguanide) hydrochloride; 3,4,4′-trichlorocarbanilide; titanium dioxide; barium monohydrate; zinc pyrithione derivatives; silver, copper, or zinc compounds in various forms (e.g., elemental, zeolite, amorphous glass, sol-gel formulations, and other ion-exchange formulations); and isothiazolone-based compounds such as 1,2-benzisothiazolin-3-one; N-butyl-1,2-benzisothiazolin-3-one, 2-octyl-isothiazolone; 4,5-dichloro-2-N-octyl-3(2H)-isothiazolone; methyl-3(2H)isothiazolone; and chloro-2-methyl-3(2H)-isothiazolone.

Because several of the above antimicrobial agents are capable of reacting with the melamine formaldehyde resin, they must consequently first be blended such that they are effectively encapsulated in a carrier compatible with melamine formaldehyde. This carrier, containing the antimicrobial agent(s), can be added to the melamine formaldehyde, typically in the bath when making solid surface materials or within the resin itself when compressed.

Antimicrobial property can be imparted to the melamine article at lower cost if the antimicrobial agent can be preferentially concentrated or disposed near the surface of the melamine coating layer. Continuing the above representative example of a laminate product, a plurality of overlay sheets can be applied, with the topmost overlay sheet having disposed therein an antimicrobial agent.

Alternatively, more than the topmost overlay sheet can include the antimicrobial agent, such as applications in which the durability of the outermost overlay sheet is a concern.

Also contemplated herein are products made from melamine resin having the antimicrobial agent incorporated therein. In the broadest sense, such products include dinnerware, cups, glasses, flooring, countertops, tabletops, and cutting boards, each of which exhibits permanent antimicrobial properties during the useful life of the article.

Representative molded melamine articles are made by injecting or otherwise introducing a liquid melamine resin composition into a mold, followed by curing of the resin to harden the melamine in the desired shape. Resin molding conventionally is performed in a temperature range of from about 154° C. to about 171° C. and under pressure in the range of from about 2000 psi to about 5000 psi.

What is claimed is:

1. A permanent antimicrobial melamine resin, comprising:
melamine; and
a first antimicrobial agent dispersed in the melamine resin, wherein the first antimicrobial agent is one of triclosan, a silver compound, a copper compound, or a zinc compound.

2. The permanent antimicrobial melamine resin of claim 1 wherein the first antimicrobial agent is a silver compound.

3. The permanent antimicrobial melamine resin of claim 1 wherein the weight percent addition of the first antimicrobial agent is about 0.1% to about 5% on of the weight of the melamine resin.

4. The permanent antimicrobial melamine resin of claim A3 wherein the weight percent addition of the first antimicrobial agent is in the range of about 0.3% to about 1.0% of the weight of the melamine resin.

5. The permanent antimicrobial melamine resin of claim 1, further comprising:
a second antimicrobial agent selected from the group consisting of triclosan; ortho phenyl phenol; diiodomethyl p-tolylsulfone; a zinc pyrithione; a sodium pyrithione; an azole; poly (hexamethylene biguanide) hydrochloride; 3,4,4′-trichlorocarbanilide; titanium dioxide; barium monohydrate; a silver compound; a copper compound; and a zinc compound.

6. The permanent antimicrobial melamine resin of claim A5 wherein the second antimicrobial agent is one of triclosan, a silver compound, a copper compound, or a zinc compound.

7. A decorative antimicrobial melamine laminate, comprising:
a substrate impregnated with a resin;
a decorative paper layer impregnated with a melamine resin; and
a first overlay sheet impregnated with a melamine resin having therein a first antimicrobial agent;
wherein the first antimicrobial agent is one of triclosan, a silver compound, a copper compound, or a zinc compound.

8. The decorative antimicrobial melamine laminate of claim 7 wherein the laminate is cured in a press at a pressure in the range of about 1000 psi to about 1500 psi and at temperature in the range of about 170° C. to about 210° C.

9. The decorative antimicrobial melamine laminate of claim 8 wherein the laminate is cured at a temperature of about 190° C.

10. The decorative antimicrobial melamine laminate of claim 7 wherein the weight percent addition of the antimicrobial agent is about 0.1% to about 5% of the weight of the melamine resin.

11. The decorative antimicrobial melamine laminate of claim 10 wherein the weight percent addition of the antimicrobial agent is about 0.3% to about 1.0% of the weight of the melamine resin.

12. The decorative antimicrobial melamine laminate of claim 7, further comprising:
a second antimicrobial agent.

13. The decorative antimicrobial melamine laminate of claim 7 wherein the second antimicrobial agent is one of: triclosan; ortho phenyl phenol; diiodomethyl p-tolylsulfone; zinc pyrithione; sodium pyrithione; an azole; poly (hexamethylene biguanide) hydrochloride; 3,4,4′-trichlorocarbanilide; titanium dioxide; barium monohydrate; a silver compound; a copper compound; or a zinc compound.

14. The decorative antimicrobial melamine laminate of claim 7, further comprising:
a second overlay sheet interposed between the first overlay sheet and the paper layer.

15. The decorative antimicrobial melamine laminate of claim 14 wherein the second overlay sheet is impregnated with a melamine resin containing a third antimicrobial agent.

16. The decorative antimicrobial melamine laminate of claim 15 wherein the third antimicrobial agent is different from the first antimicrobial agent.

17. The decorative antimicrobial melamine laminate of claim 15 wherein the first antimicrobial agent is disposed in the first overlay sheet at a first agent concentration and the third antimicrobial agent is disposed in the second overlay sheet at a third agent concentration; and
wherein the first agent concentration and the third agent concentration are unequal.

18. A laminate article, comprising:
a substrate;
a decorative paper layer impregnated with a melamine resin;
an first antimicrobial agent; and
a first overlay sheet impregnated with a melamine resin including a first antimicrobial agent.

19. The laminate article of claim 18 wherein the article is a countertop, a tabletop, a desktop, or a flooring article.

20. The laminate article of claim 18 wherein the first antimicrobial agent is one of: triclosan; ortho phenyl phenol; diiodomethyl p-tolylsulfone; zinc pyrithione; sodium pyrithione; an azole; poly (hexamethylene biguanide) hydrochloride; 3,4,4′-trichlorocarbanilide; titanium dioxide; barium monohydrate; a silver compound; a copper compound; or a zinc compound.

21. The laminate article of claim 18 wherein the weight percent addition of the antimicrobial agent is about 0.1% to about 5% of the weight of the melamine resin.

22. The laminate article of claim 21 wherein the weight percent addition of the antimicrobial agent is about 0.3 to about 1.0% of the weight of the melamine resin.

23. The laminate article of claim 18, further comprising:
a second antimicrobial agent.
